(19) United States
(12) Patent Application Publication
(10) Pub. No.: US 2008/0112098 A1
(43) Pub. Date: May 15, 2008

(54) Separate box assembly for voltage surge protection

(76) Inventor: James W. Stone, Northbrook, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/599,652

(22) Filed: Nov. 15, 2006

(51) Int. Cl. H02H 9/08; H02H 3/22

(52) U.S. Cl. 361/42; 361/111

(57) ABSTRACT

A separate box assembly for protecting telecommunications related equipment and associated sensitive electrical loads connected to AC electrical power lines components from AC transient voltage surges includes a circuit breaker panel disposed in an electrical power distribution network for receiving incoming power lines. Distinct branch circuits are coupled through household wiring and terminates in AC outlets for connecting to customers' electrical loads to be protected. A plurality of protection modules are interconnected between the circuit breaker panel and the distinct branch circuits. Each of the plurality of protection modules includes AC over-voltage protection circuitry.

### BACKGROUND OF THE INVENTION

1. Field of the Invention

This invention relates generally to transient voltage surge suppressors (TVSS) for protecting telecommunications related equipment and associated sensitive electrical loads connected to AC electrical power lines from AC transient voltage surges. More particularly, the present invention relates to a separate box assembly for voltage surge protection interconnected between a circuit breaker panel in an electrical power distribution network and distinct selected branch circuits of household wiring. Specifically, the separate box assembly of the instant invention includes a plurality of over-voltage protection modules each being uniquely designed so as to receive therein one of AC over-voltage protection circuitry, ground fault circuit interrupter (GFCI), and/or load indicator circuitry.

2. Description of the Prior Art

As is generally well known to those skilled in the electrical power industry, electrical power lines are susceptible to transient surges such as those caused by lightning strikes and other voltage surges on the transmission lines. Accordingly, various types of surge protector circuits known in the prior art have been provided for coupling to the incoming transmission lines for protecting the sensitive electrical loads connected thereto.

As used herein, the term “transmission lines” refers to various types of wires or conductors in a power distribution network provided by electric utility companies for carrying power, voice signals, data signals and the like to a users' or consumers' electrical loads. The voice/data signals may be used for transmitting and/or receiving signals to and from various types of office equipment, such as telephone sets, computers, facsimile machines, photocopiers, alarm devices, modems, and the like.

In the typical electrical power distribution network, the transmission lines provided by the utility companies for carrying the power are brought into a household building or premise and are connected to a circuit breaker panel, which is used to separate the power for interconnection to a number of distinct branch circuits (15 or 20 amp sizes). Each of the branch circuits is coupled through household wiring and terminates in standard duplex 110 VAC outlets to which different kinds of consumers' electrical loads, such as lighting, appliances and electronic devices, are connected. Heretofore, in order to protect such electrical loads from over-voltage surges, a surge protected power strip with an extension cord and containing a plurality of 110 VAC outlets is being used for interconnection between the duplex outlets and the different kinds of consumers' electrical loads.

In order to eliminate the need for the consumers to connect a large number of surge protected power strips to the standard duplex outlets throughout the household premises, it would be desirable to provide a separate protection box assembly for voltage surge protection interconnected between a circuit breaker panel in an electrical distribution network and distinct selected branch circuits of household wiring. Specifically, the separate protection box assembly includes a plurality of over-voltage protection modules each being uniquely designed so as to receive therein one of AC over-voltage protection circuitry, ground fault current interrupter (GFCI), and/or load indicator circuitry.

### SUMMARY OF THE INVENTION

Accordingly, it is a general object of the present invention to provide a separate box assembly for voltage surge protection which is relatively simple and economical to manufacture and assemble.

It is an object of the present invention to provide a separate box assembly for protecting telecommunications related equipment and associated sensitive electrical loads connected to AC electrical power lines from transient voltage surges which includes a plurality of uniquely-designed modules each being suitable for receiving therein one of AC over-voltage protection circuitry, ground fault current interrupter, and/or load indicator circuitry.

It is another object of the present invention to provide a separate box assembly for voltage surge protection which is characterized by a design wherein a plurality of modules are mounted on bus strips for facilitating routing of the wiring for distinct branch circuits through a circuit breaker panel.

It is still another object of the present invention to provide a separate box assembly for protecting telecommunications related equipment and associated sensitive electrical components from AC transient voltage surges which includes LED indicator devices for indicating presence of power, of a ground fault, and/or of varying load current being supplied.

In a preferred embodiment of the present invention, there is provided a separate box assembly for protecting telecommunications related equipment and associated sensitive electrical loads connected to AC electrical power lines components from AC transient voltage surges which includes a circuit breaker panel disposed in an electrical power distribution network for receiving incoming power lines. Distinct branch circuits are coupled through household wiring and terminates in AC outlets for connecting to customers' electrical loads to be protected. A plurality of protection modules are interconnected between the circuit breaker panel and the distinct branch circuits. Each of the plurality of protection modules includes AC over-voltage protection circuitry.

### BRIEF DESCRIPTION OF THE DRAWINGS

These and other objects and advantages of the present invention will become more fully apparent from the following detailed description when read in conjunction with the accompanying drawings with like reference numerals indicating corresponding parts throughout, wherein:

FIG. 1 is a front plan view of a separate box assembly for voltage surge protection, constructed in accordance with the principles of the present invention;

FIG. 2 is a front plan view of one of the plurality of over-voltage protection modules in the separate box assembly of FIG. 1;

FIG. 3 is a rear view of one of the plurality of over-voltage protection modules in the separate box assembly of FIG. 1;

FIG. 4a is a top plan view of one of the plurality of over-voltage protection modules in the separate box assembly of FIG. 1;

FIG. 4b is a right side elevational view of one of the plurality of over-voltage protection modules in the separate box assembly of FIG. 1;

FIG. 5 is a functional block diagram of an over-voltage protection circuit for use in the modules of FIG. 1;

FIG. 6 is a schematic circuit diagram of the over-voltage protection circuit of FIG. 5;

FIG. 7 is functional block diagram of an alternate protection circuitry for use in the modules of FIG. 1; and

FIG. 8 is a functional block diagram of a second alternate protection circuitry for use in the modules of FIG. 1.

### DESCRIPTION OF THE PREFERRED EMBODIMENTS

It is to be distinctly understood at the outset that the present invention shown in the drawings and described in detail in conjunction with the preferred embodiments is not intended to serve as a limitation upon the scope or teachings thereof, but is to be considered merely an exemplification of the principles of the present invention.

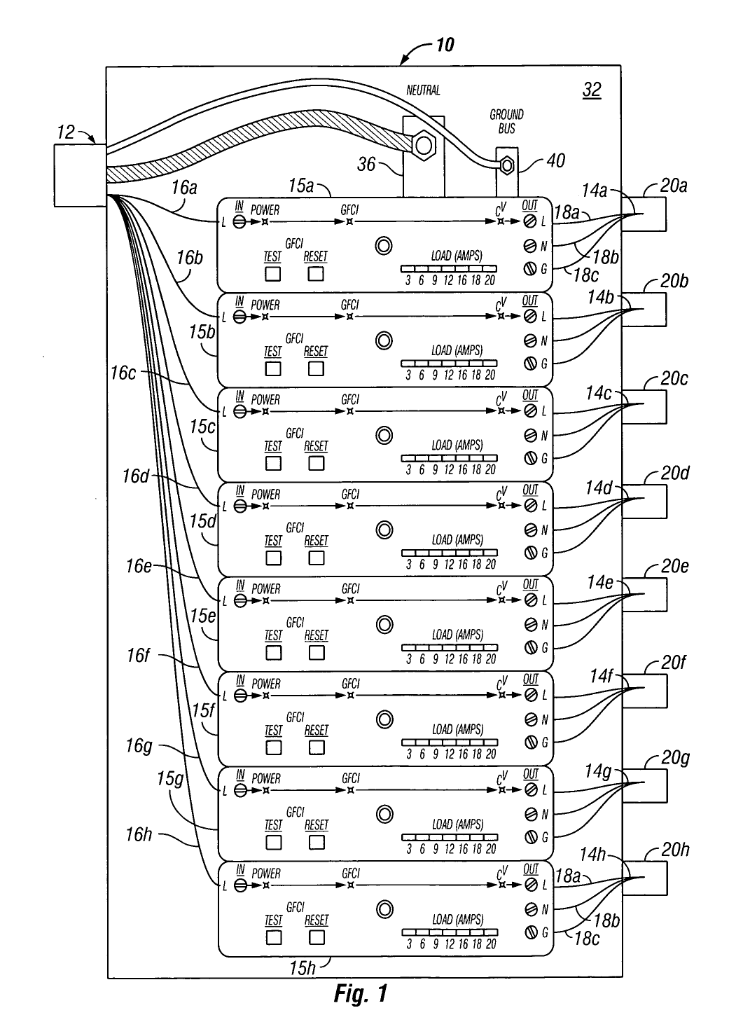

Referring now in detail to the various views of the drawings and in particular to FIGS. 1 through 4, there is illustrated a separate box assembly 10 for voltage surge protection which is constructed in accordance with the principles of the present invention. The separate box assembly 10 has particular applications for interconnection between a circuit breaker panel 12 in a power distribution network in common use in telecommunications related equipment and distinct selected branch circuits 14a through 14h of household wiring connectible to different kinds of consumers' sensitive electrical loads so as to protect the same from damage caused by transient voltage surges.

The transmission lines (not shown) in the power distribution network provided by the electric utility company for carrying power are connected to the input side of the circuit breaker panel 12. The separate box assembly 10 includes a plurality of over-voltage protection modules 15a-15h each being uniquely-design so as to receive therein AC over-voltage protection circuitry.

Each one of the modules 15a-15h is connected to a respective one of the individual power conductor wires 16a-16h which is joined to the output side of the circuit breaker panel 12. The output side of the modules 15a-15h is connected to a corresponding one of the branch circuits 14a-14h. It will be noted that each branch circuit consists of a power line 18a, a neutral line 18b, and a ground line 18c which are connectible to a corresponding one of a plurality of standard 110 AC outlets 20a-20h located throughout a consumer's household building or premise.

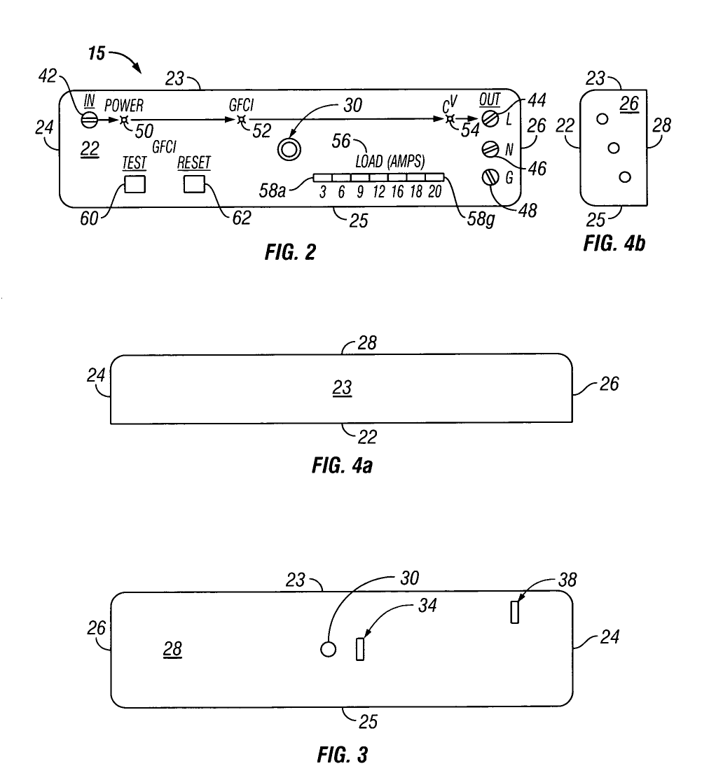

Each of the modules 15a-15h (one 15 of which being shown in FIGS. 2-4a) includes a substantially rectangular-shaped housing having a unique construction and made of a suitable material, such as plastic and the like. Each module is comprised of a front wall member 22, opposed side wall members 24 and 26, opposed top and bottom wall members 23 and 25, and a rear wall member 28, all interconnected together so as to form an enclosure. Each of the module 15a-15h is of a relatively compact size so as to accommodate a number of different types of protection circuitry in a very limited amount of space area and is adapted to be mounted in a power distribution cabinet wiring panel similar to one used for the circuit breaker panel 12.

As can best be seen from FIGS. 1 and 2, the front wall member 22 includes a centrally-located through-hole 30 which is adapted to receive a mounting screw to facilitate mechanical connecting of the module 15 to a surface wall panel 32 within the separate box assembly 10. In FIG. 3, the rear wall member 28 includes a first slot 34 for receiving a neutral spade (not shown) connected to a neutral bus strip 36 (FIG. 1) and a second slot 38 for receiving a ground spade (not shown) connected to a ground bus strip 40. The bus strips 36 and 40 run through each of the modules 15a-15h. The modules are grounded by the ground bus strip 40 which is electrically connected to an electrical ground, such as a building ground wire.

In FIG. 2, the front wall member 22 further includes an input terminal or connection post member 42 for receiving one of the power conductor wires 16a-16h. There is also provided three output terminals or connection post members 44, 46, and 48 for connection to a corresponding one of the power line 18a, neutral line 18b, and ground line 18c of the branch circuits 14a-14h.

A first LED indicator 50 is provided and indicates a proper power connection. The LED indicator 50 is a power indicator and lights up “green” to indicate when power is present. A second LED indicator 52 is also provided and is used to indicate a ground fault. The LED indicator 52 lights up “green” when the circuit is operating normally and will become “red” when a ground fault is detected.

A third LED indicator 54 is provided and is used to indicate an over-voltage condition. The LED indicator 54 lights up “green” when power is present and will become “red” when there is an over-voltage to indicate that power has been disconnected from the load. A segmented LED display 56 is provided and includes green, yellow and red segments 58a-58g so as to indicate the varying amounts of load current being supplied. In addition, there are provided two pushbutton switches 60 and 62 which are used to test and to reset the ground fault circuit.

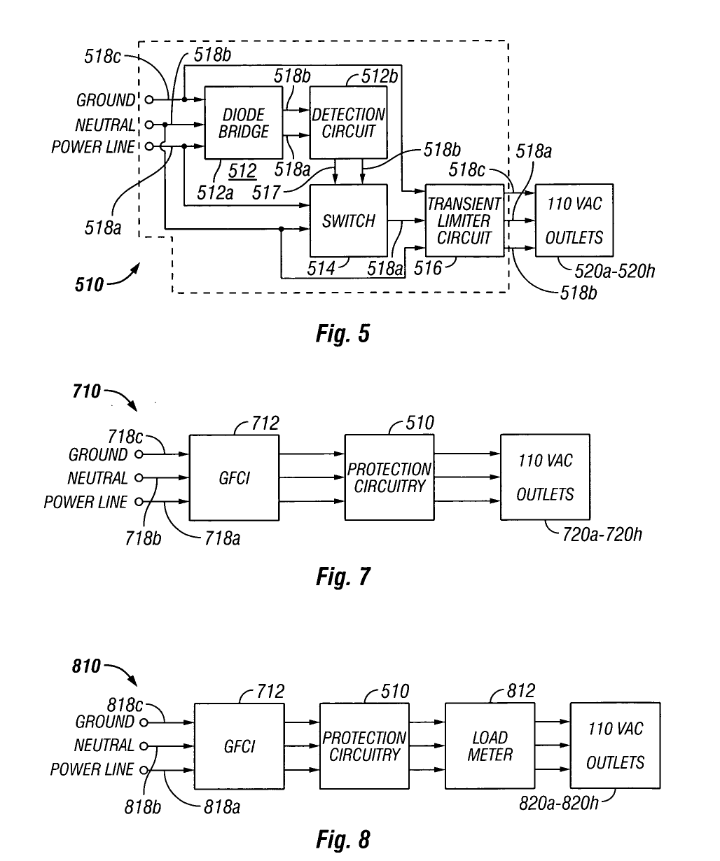

In FIG. 5, there is shown a functional block diagram of an over-voltage protection circuit 510 for use in the modules 15a-15h of FIG. 1 so as to protect the associated standard 110 VAC duplex outlets 20a-20h, to which different kinds of consumers' electrical loads, such as lighting, appliances, sensitive electronic devices and the like are connected, against sustained over-voltage conditions.

The protection circuit 510 includes a voltage detection circuit 512 consisting of a diode bridge 512a and a detection circuit 512b, a switch 514, and transient limiter circuit 516. The power line 518a, neutral line 518b, and ground line 518c are connected to the voltage detection circuit 512, the switch 514 and the transient limiter circuit 516. The voltage detection circuit 512 monitors the line-neutral, line-ground, and neutral-ground inter-terminal voltage for an over-voltage condition appearing between any pair of the terminals.

If any one or more of the inter-terminal voltages exceeds a predetermined voltage, the voltage detection circuit 512 will, via a control line 517, cause the switch 514 to interrupt the current path of the incoming power line 518a to the transient limiter circuit 516 and the 110 VAC duplex outlets 520a-520h to which the loads to be protected are connected.

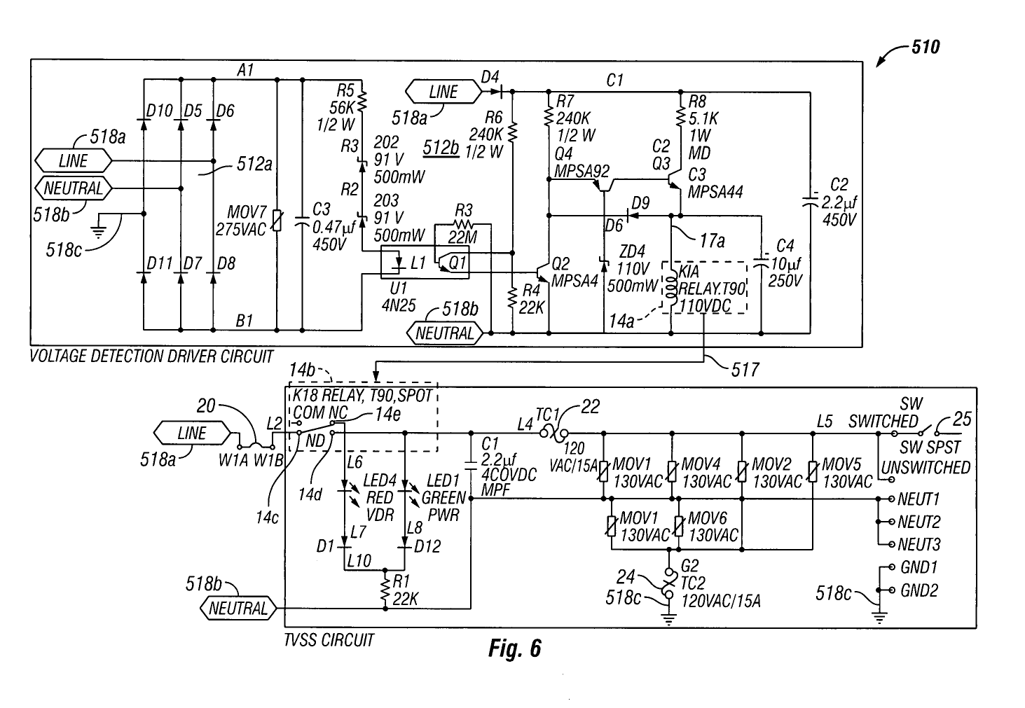

A schematic circuit diagram of one implementation of the over-voltage protection circuit of FIG. 5 is illustrated in FIG. 6. FIG. 6 is identical to the over-voltage protection circuit of FIG. 2 in U.S. Pat. No. 6,816,350 issued on Nov. 9, 2004 to Michael L. Hoopes and entitled “AC Voltage Protection Circuit”. This '350 patent is assigned to the same assignee as the present invention, which is hereby incorporated by reference in its entirety. Since a detailed description of the circuit components and the operation thereof of FIG. 2 is described in the '350 patent, it is believed that a further explanation of FIG. 6 is not required.

As can be seen from FIG. 7, there is illustrated a functional block diagram of an alternate protection circuitry 710 for use in the modules of FIG. 1. The protection circuitry 710 includes the protection circuitry 510 of FIG. 5 and a ground fault circuit interrupter (GFCI) 712. The power line 718a, neutral line 718b, and ground line 718c are connected to the input side of the GFCI 712 and the output side thereof is connected to the input of the protection circuitry 510.

The GFCI 712 is used to detect the presence of abnormal current flow, e.g., faulted current flow from the power line 718a to the ground line 718c, and to interrupt immediately power to the faulted line in order to protect against the power from reaching the plurality of 110 VAC outlets 720a-720h. It should be understood that the protection circuitry 710 may alternatively contain only the GFCI 712.

In FIG. 8, there is illustrated a functional block diagram of a second alternate protection circuitry 810 for use in the modules of FIG. 1. The protection circuitry 810 includes the protection circuitry 510 of FIG. 5, the ground fault circuit interrupter (GFCI) 712 of FIG. 7, and a load meter 812. The power line 818a, neutral line 818b, and ground line 818c are connected to the input side of the GFCI 712 and the output side thereof is connected to the input of the protection circuitry 510. The output side of the protection circuitry 510 is connected to the input of the load meter 812.

The load meter is used to measure a voltage from a current transformer in order to indicate the amount of current being drawn by the plurality of 110 VAC outlets 820a-820h. The GFCI 712 is used to detect the presence of abnormal current flow, e.g., faulted current flow from the power line 818a to the ground line 818c, and to interrupt immediately power to the faulted line in order to protect against the power from reaching the plurality of 110 VAC outlets 820a-820h. The load meter 812 may include light-emitting diodes LEDs for indicating the different levels of current being drawn. It should be understood that the protection circuitry 810 may alternatively contain only the load meter 812.

From the foregoing detailed description, it can thus be seen that the present invention provides a separate box assembly for protecting telecommunications related equipment and associated sensitive electrical loads connected to AC electrical power lines from AC transient voltage surges which includes a circuit breaker panel disposed in an electrical power distribution network for receiving incoming power lines. Distinct branch circuits are coupled through household wiring and terminates in AC outlets for connecting to customers' electrical loads to be protected. A plurality of protection modules are interconnected between the circuit breaker panel and the distinct branch circuits. Each of the plurality of protection modules includes AC over-voltage protection circuitry.

While there has been illustrated and described what are at present considered to be preferred embodiments of the present invention, it will be understood by those skilled in the art that various changes and modifications may be made, and equivalents may be substituted for elements thereof without departing from the true scope of the invention. In addition, many modifications may be made to adapt a particular situation or material to the teachings of the invention without departing from the central scope thereof. Therefore, it is intended that this invention not be limited to the particular embodiments disclosed as the best modes contemplated for carrying out the invention, but that the invention will include all embodiments falling within the scope of the appended claims.

What is claimed is:

1. A separate box assembly for protecting telecommunications related equipment and associated sensitive electrical loads connected to AC electrical power lines components from AC transient voltage surges, comprising:
a circuit breaker panel disposed in an electrical power distribution network for receiving incoming power lines;
distinct branch circuits coupled through household wiring and terminating in AC outlets for connecting to customers' electrical loads to be protected;
a plurality of protection modules interconnected between said circuit breaker panel and said distinct branch circuits; and
each of said plurality of protection modules including AC over-voltage protection circuitry.

2. A separate box assembly as claimed in claim 1, wherein said AC over-voltage protection circuitry includes a voltage detection circuit, a switch, and a transient limiter circuit.

3. A separate box assembly as claimed in claim 1, wherein said AC over-voltage protection circuitry includes a ground fault circuit interrupter and a protection network formed of a voltage detection circuit, a switch, and a transient limiter circuit.

4. A separate box assembly as claimed in claim 1, wherein said AC over-voltage protection circuitry includes a ground fault circuit interrupter; a protection network formed of a voltage detection circuit, a switch, and a transient limiter circuit; and a load meter.

5. A separate box assembly as claimed in claim 1, wherein said each of said plurality of protection modules is formed of a front wall, a rear wall, opposed side walls, opposed top and bottom walls and end walls, all interconnected together so as to form an enclosure.

6. A separate box assembly as claimed in claim 1, wherein said each of said plurality of protection modules are connectible to neutral and ground bus strips for facilitating routing of the wiring for said distinct branch circuits through said circuit breaker panel.

7. A separate box assembly as claimed in claim 1, further comprising indicator means for indicating the presence of power.

8. A separate box assembly as claimed in claim 3, further comprising indicator means for indicating a ground fault.

9. A separate box assembly as claimed in claim 4, further comprising means for indicating varying load current being supplied.

10. A separate box assembly as claimed in claim 8, further comprising switching means for testing and resetting of a ground fault.

11. A separate box assembly for protecting telecommunications related equipment and associated sensitive electrical loads connected to AC electrical power lines components from AC transient voltage surges, comprising:
circuit breaker means disposed in an electrical power distribution network for receiving incoming power lines;
distinct branch circuit means coupled through household wiring and terminating in AC outlets for connecting to customers' electrical loads to be protected;
protection module means interconnected between said circuit breaker means and said distinct branch circuit means; and
said protection module means including AC over-voltage protection circuitry.

12. A separate box assembly as claimed in claim 11, wherein said AC over-voltage protection circuitry includes a voltage detection circuit, a switch, and a transient limiter circuit.

13. A separate box assembly as claimed in claim 11, wherein said AC over-voltage protection circuitry includes a ground fault circuit interrupter and a protection network formed of a voltage detection circuit, a switch, and a transient limiter circuit.

14. A separate box assembly as claimed in claim 11, wherein said AC over-voltage protection circuitry includes a ground fault circuit interrupter; a protection network formed of a voltage detection circuit, a switch, and a transient limiter circuit; and a load meter.

15. A separate box assembly as claimed in claim 11, wherein said protection module means is formed of a front wall, a rear wall, opposed side walls, opposed top and bottom walls and end walls, all interconnected together so as to form an enclosure.

16. A separate box assembly as claimed in claim 11, wherein said protection module means are connectible to neutral and ground bus strips for facilitating routing of the wiring for said distinct branch circuit means through said circuit breaker means.

17. A separate box assembly as claimed in claim 11, further comprising indicator means for indicating the presence of power.

18. A separate box assembly as claimed in claim 13, further comprising indicator means for indicating a ground fault.

19. A separate box assembly as claimed in claim 14, further comprising indicator means for indicating varying load current being supplied.

20. A separate box assembly as claimed in claim 18, further comprising switching means for testing and resetting of a ground fault.
